(19) United States
(12) Patent Application Publication
(10) Pub. No.: US 2026/0029692 A1
(43) Pub. Date: Jan. 29, 2026

(54) TRIPOD FOR PHOTOGRAPHIC DEVICES

(71) Applicant: : Zhongshan Firefly Image Technology CO., LTD, Zhongshan City (CN)

(72) Inventors: Lifeng Yu, Zhongshan City (CN); Gui Li, Zhongshan City (CN); Chunyang Jiang, Bradenton, FL (US)

(73) Assignee: : Zhongshan Firefly Image Technology CO., LTD, Zhongshan City (CN)

(21) Appl. No.: 19/074,609

(22) Filed: Mar. 10, 2025

(30) Foreign Application Priority Data
Jul. 24, 2024 (CN) 202421773799.3

(51) Int. Cl. G03B 17/56; F16M 11/34

(52) U.S. Cl. CPC G03B 17/561; F16M 11/34

(57) ABSTRACT

The purpose of the photographic tripod is to prevent movement of the photographic device during the capture of an image. In addition, the photographic tripod should enable the user to precisely position the camera relative to the floor and the object that is being photographed. Tripod legs, when unfolded, create an effective circular base. However because of the way they are constructed tripods typically allow the legs to unfold to a fixed angle essentially 45 degrees to the vertical. As the camera height position is increased, this makes the base that's created less stable. The invention makes use of novel structures to enable continuous angular leg adjustment, between, essentially, 0 and 90 degrees. As such, it allows a wider, effective, circular base and more secure support.

This application claims priority from Chinese Patent Application No. 202421773799.3, titled “Tripod,” filed on Jul. 24, 2024, with the China National Intellectual Property Administration. The entire content of the prior application is incorporated herein by reference.

### TECHNICAL FIELD

The invention is a tripod system for supporting photographic devices.

### BACKGROUND OF INVENTION

Photographic devices benefit by being supported by a tripod system. It is important that photographic devices do not move vertically or horizontally in order to have high resolution, accurate images. A tripod system is capable of supporting a photographic device such that it is essentially immobile during image capture. However, contemporary tripods have adjustment limitations that may affect the positioning of the photographic device. For example, the unfolding tripod legs may be limited to one angular position relative to the vertical. The highest degree of support occurs when the legs are at essentially 90 degrees to the vertical but contemporary tripods do not support that.

### BRIEF DESCRIPTION OF THE INVENTION

The invention herein disclosed is a tripod whose subsystems support adjusting the leg-to-vertical angle from essentially 0 to 90 degrees in a continuously adjustable way. Once a desired angle is selected the legs van be locked into that position. Continuously adjustable leg extension and locking allows precise height-above-base vertical positioning.

The invention comprises a fixed hub subsystem to which one end of each of three or more legs are affixed to joints allowing leg rotation in a plane orthogonal to the hub's orientation. When the hub is oriented horizontally, it has an aperture at its center whose axis is vertical. A movable, tubular, rod subsystem fits within that aperture and may move up or down, axially, while held steady, horizontally.

At one end of the movable, tubular, rod is a mounting fixture for a photographic device. At the opposite end is a fixture for affixing the ends of three or more leg-to-rod connecting subsystems. These ends are interfaced to fixtures so as to allow rotation in a vertical plane. At the other end of each connecting rod is an end that affixes to a structure on each leg that allows connecting rod rotation in a vertical plane.

The structure described enables the legs to be unfolded in a continuous way until a desired leg position is obtained. As legs are adjusted, the movable, tubular rod will slide up or down through the fixed hub's aperture. A locking knob on the fixed hub can lock the movable rod in the chosen position.

Further height adjust can be made by extending telescopic elements of the legs and then locking them in the chosen height position.

In this way, height and base support can be selected for optimal tripod stability.

### BRIEF DESCRIPTION OF DRAWINGS

FIG. 1 depicts the tripod system folded and retracted.

FIG. 2 shows the system of FIG. 1 in an exploded view.

FIG. 3 shows the system of FIG. 1 with the legs partially unfolded.

FIG. 4 shows that as the legs are unfolded the leg-to-rod subsystems apply force to the base of the rod causing the rod to move vertically upward. Simultaneously, the sliding leg fixture slides in a downward direction

FIG. 5 shows that each leg is made up of telescoping sections that can be extended and locked in place so as to adjust the height of the entire system once the position of the movable, tubular rod is set.

FIG. 6 shows an inside view of a leg wherein the telescoping sections are depicted along with the locking fixtures that lock each section in place.

FIG. 7 shows that the legs may be unfolded so that the angle between the legs and the movable tubular rod can be essentially 90 degrees.

### DETAILED DESCRIPTION OF INVENTION

Many photographic devices have built-in motion compensation but nothing is as solid as having the device mounted on a tripod.

Contemporary tripods have legs that will unfold to a fixed angle relative to the vertical. Once so adjusted further height is adjusted by moving the movable tubular rod. In such tripods unfolding the legs has no effect on the position of the tubular rod relative to its fixed hub. As the height is increased the stability of the tripod is impacted because the base formed by the unfolded legs remains fixed.

The invention herein disclosed has subsystems which allow the legs to be unfolded such that the angle between the legs and the movable tubular rod can smoothly and continuously increase from essentially 0 to 90 degrees.

With an angle of 90 degrees between the legs and the movable tubular rod, and the legs sections fully extended, the base that is formed may support the photographic device regardless of the height of the movable tubular rod and any extensions.

The figures and descriptions that follow are meant to be exemplary and should not be read as limiting the scope of the claims.

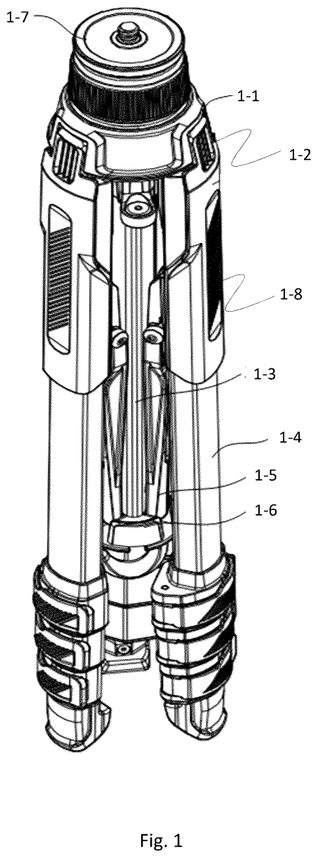

FIG. 1 shows the invention in a fully retracted and folded state. A fixed hub (1-1), is attached to the edges of three legs forming a hinged interface (1-2). Passing through an aperture in the fixed hub is a movable tubular rod subsystem (1-3), that is able to move up or down vertically with respect to the hub, when the hub is oriented horizontally. Each of the three or more legs (1-4) has a leg-to-rod subsystem (1-5) which is connected to a sliding fixture on the leg (1-8) and the fixed base fixture at the bottom of the rod (1-6).

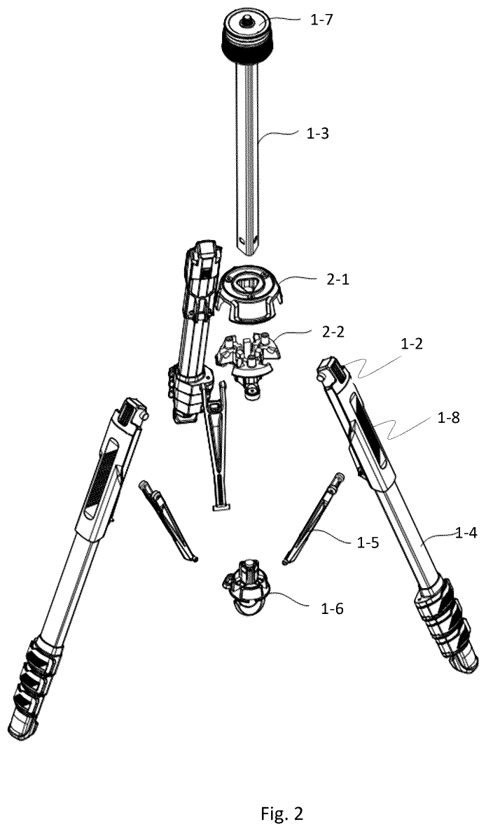

FIG. 2 is an exploded view of the figure of FIG. 1 wherein the hub is shown as comprising an upper (2-1) and lower portion (2-2) that fit together. Note that the movable tubular rod subsystem (1-3) as well as the aperture in the upper portion (2-1) have a complementary polygonal profile. In FIG. 2, it is a triangular profile. This allows the rod to move up and down freely while resisting rotation of the rod in a plane orthogonal to its axis. The profile could also be rectangular, hexagonal, and so on. The leg joint fixtures (1-2) are set in place in the lower portion of the fixed hub (2-2) and then the upper portion (2-1) is put in place and attached to the lower portion.

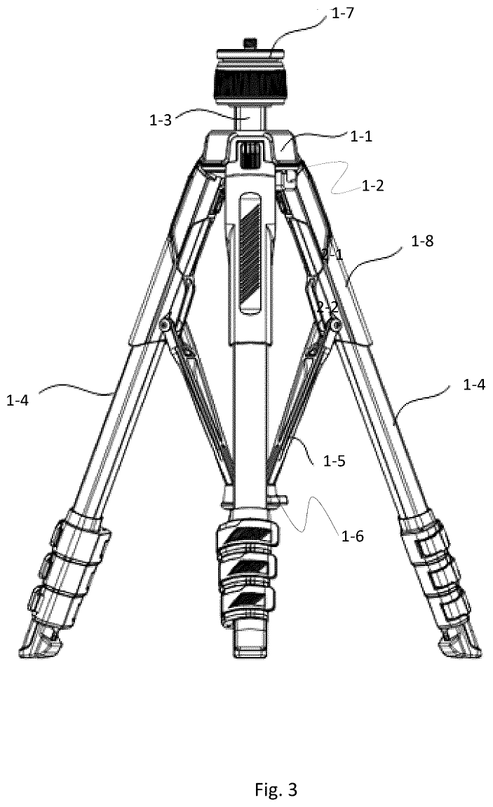

FIG. 3 shows the tripod system with the legs partially unfolded. As shown the leg-to-rod connecting subsystem (1-5) is connected to a sliding leg fixture subsystem (1-8) on the leg and to the fixed-base fixture (1-6) of the rod. The other subsystems 1-1, 1-2, 1-3, 1-4, and 1-7 are also shown and have been previously described.

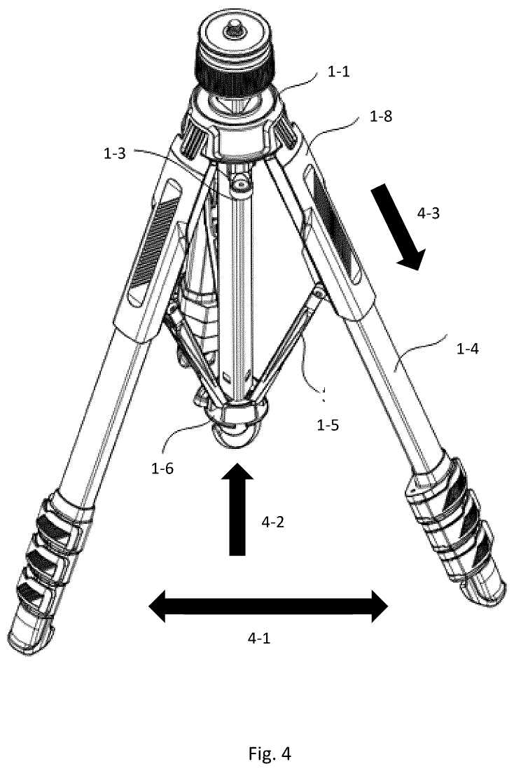

As shown in FIG. 4, as the legs (1-4) are further unfolded (4-1) the leg-to-rod connecting system (1-5) applies force to the fixed base of the rod (1-6) causing the rod to move upward (4-2) at the same time the sliding leg connecting fixtures (1-8) slide downward (4-3). The other subsystems, 1-1, 1-3, and 1-4, are shown and had been previously described. As the angle between the legs and vertical increase from 0 to a maximum of 90 degrees, once a position is selected, the legs can be locked into position using a locking knob on the fixed hub (not shown) which is tightened against the rod holding it in a locked position.

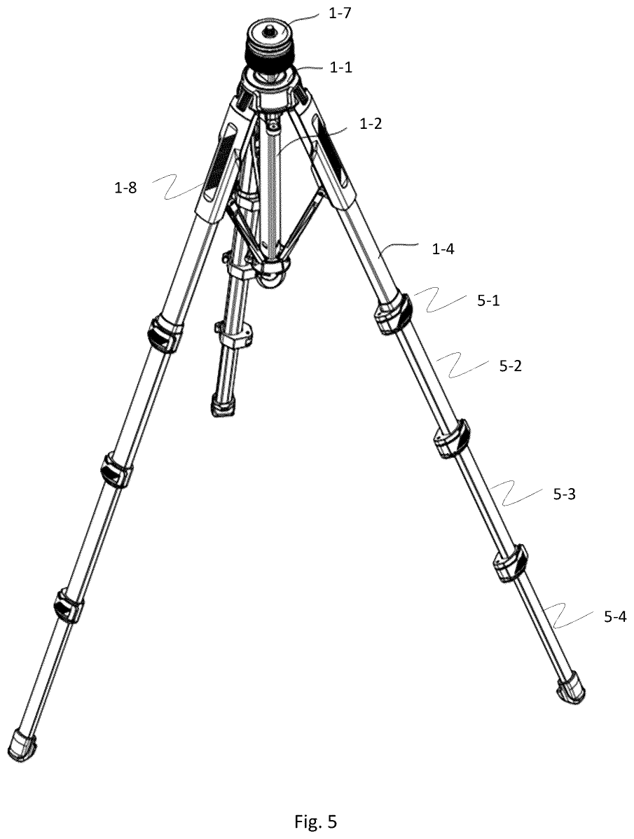

In FIG. 5 once the angle between the legs and the vertical has been selected and locked, the height of the tripod system's mounting fixture can be adjusted by extending the telescoping sections (5-2, 5-3, 5-4) of each leg to adjust the overall height of the tripod. Each telescoping section has a locking fixture, such as 5-1, which can be locked once the extension position has been selected. The other subsystems, 1-1, 1-2, 1-4, 1-7 and 1-8, are shown and have been previously described.

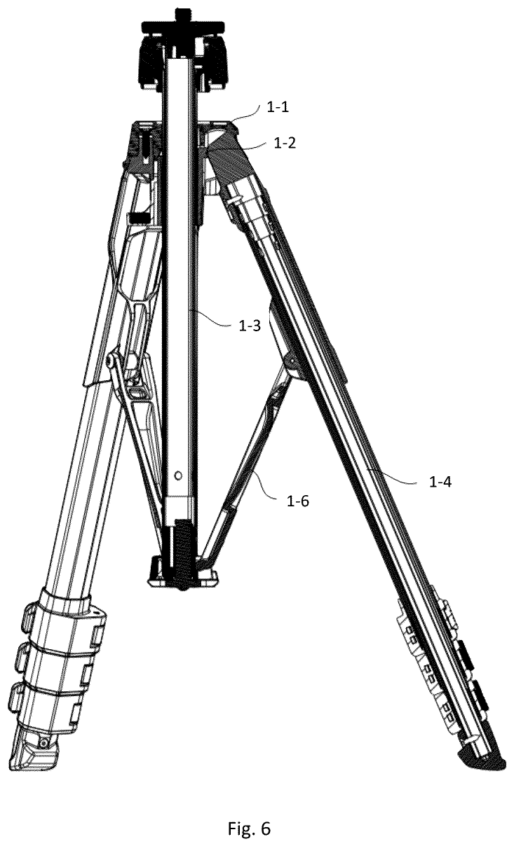

In FIG. 6, one leg shows an interior view showing the concentric interleaving of the sections that can be extended to increase the height.

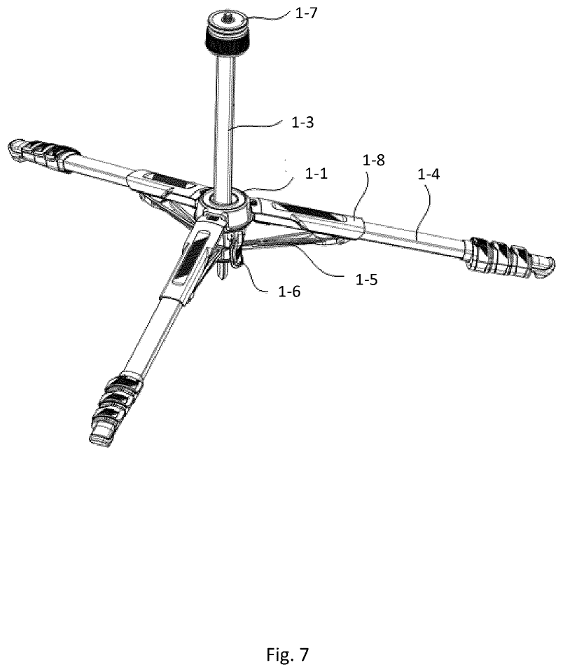

In FIG. 7 the three legs (1-4) have been unfolded essentially orthogonal to the vertical, as shown. The base of the rod and the ends of the legs form a broad effective circular base whose radius is approximately the length of the leg. If the legs are extended, the radius is increased, and the circumference of the circular base is therefore even larger. Subsystems 1-1, 1-3, 1-4, 1-5, 1-6, 1-7 and 1-8 are shown and have been previously described.

What is claimed is:

1. A tripod system comprising:
a fixed hub subsystem;
three or more telescoping, extendable and retractable legs;
three or more hub-to-leg connecting fixtures;
a movable, tubular, rod subsystem;
three or more leg-to-rod connecting subsystems;
three or more sliding leg connecting subsystems;
a photographic-device-supporting platform subsystem;
a fixed leg-to-rod connecting base subsystem;
wherein the hub-to-leg connecting fixtures comprise hinged joints enabling the legs to rotate in a plane perpendicular to the orientation of the fixed hub;
wherein the fixed hub system comprises a central aperture through which the movable, tubular, rod subsystem may move in a direction perpendicular to the orientation of the fixed hub;
wherein the central aperture and the movable, tubular, rod system have complementary polygonal profiles;
wherein each of the sliding leg connecting subsystems are operative to slide firmly along each leg and parallel to each leg's axis;
wherein the photographic-device-supporting platform subsystem is mounted on one end of the movable tubular rod subsystem; and
wherein the fixed leg-to-rod connecting subsystem is mounted on the opposite end of the movable, tubular, rod subsystem.

2. The system as in claim 1 wherein:
as the three or more telescoping, extendable and retractable legs are unfolded or folded, the three or more leg-to-rod connecting subsystems apply a force to the fixed leg-to-rod connecting base subsystem causing the movable, tubular rod to move relative to the fixed hub's central aperture; and causes sliding leg connecting subsystems to slide along the leg surface; enabling continuous angular positioning of the telescoping, extendable and retractable legs relative to the axis of the movable, tubular rod over essentially a 0 to 90 degree range.

3. The system as in claim 1 wherein:
each telescoping extendable leg comprises four telescoping sections and three locking fixtures wherein the locking fixtures are operative to permit extension or retraction, and then lock the leg extension into a selected position.

4. The system as in claim 1 wherein all subsystems are made of metal.

5. The system as in claim 1 wherein all subsystems are made of composites.
